(19) United States
(12) Patent Application Publication
(10) Pub. No.: US 2020/0412556 A1
(43) Pub. Date: Dec. 31, 2020

(54) USER DEVICE, PHYSICAL-UNCLONABLE-FUNCTION-BASED AUTHENTICATION SERVER, AND OPERATING METHOD THEREOF

(71) Applicant: ELECTRONICS AND TELECOMMUNICATIONS RESEARCH INSTITUTE, Daejeon (KR)

(72) Inventors: Seung-Yong YOON, Daejeon (KR); Byoung-Koo KIM, Daejeon (KR); You-Sung KANG, Daejeon (KR); Doo-Ho CHOI, Cheonan-si (KR); Ik-Kyun KIM, Daejeon (KR); Tae-Sung KIM, Daejeon (KR); Mi-Kyung OH, Daejeon (KR); Sang-Jae LEE, Daejeon (KR)

(73) Assignee: ELECTRONICS AND TELECOMMUNICATIONS RESEARCH INSTITUTE, Daejeon (KR)

(21) Appl. No.: 16/830,258

(22) Filed: Mar. 25, 2020

(30) Foreign Application Priority Data
Jun. 28, 2019 (KR) 10-2019-0077541

(51) Int. Cl. H04L 9/32; G06F 16/23; H04L 9/08

(52) U.S. Cl. CPC H04L 9/3278; G06F 16/2379; H04L 9/3213; H04L 9/0869; H04L 9/0891

(57) ABSTRACT

Disclosed herein is a method of operating an authentication server based on a Physical Unclonable Function (PUF), which includes transmitting a Challenge-Response Pair (CRP) update request message to a user device when a CRP update event occurs, receiving a CRP update response message from the user device in response to the CRP update request message, generating a secret key corresponding to the CRP update request message, decrypting the CRP update response message with the secret key, and updating a CRP corresponding to the secret key in a database using the decrypted CRP update response message.

### CROSS REFERENCE TO RELATED APPLICATION

This application claims the benefit of Korean Patent Application No. 10-2019-0077541, filed Jun. 28, 2019, which is hereby incorporated by reference in its entirety into this application.

### BACKGROUND OF THE INVENTION

### 1. Technical Field

The present invention relates to an authentication server based on a Physical Unclonable Function (PUF) and an operating method thereof.

### 2. Description of the Related Art

Internet-of-Things (IoT) technology is widely used in various fields, such as those of a smart home, health care, a smart factory, a smart city, and the like. With the provision and spread of new and various services in an IoT environment, the number of security vulnerabilities and security threats is rapidly increasing. However, because it is difficult to apply existing security techniques, which are used for PCs or servers, to IoT user devices without change due to the limited power sources and resources of the IoT user devices, most IoT user devices apply lightweight security techniques or minimum security functions, or run without any security function loaded thereon beforehand. As a result, security incidents, such as information leakage by hacking, Distributed Denial-of-Service (DDoS) attacks, damage due to illegal replication or falsification, and the like, continually happen, whereby economic and social losses incurred therefrom are increasing day by day.

Physical Unclonable Function (PUF) technology, which emerged in order to solve the above problems, is technology for imparting a unique hardware-specific characteristic to each user device, similar to biometric information, such as a fingerprint, an iris, or the like of a human. That is, PUF technology is digital fingerprinting technology based on different characteristics of individual user devices produced through the same manufacturing process. Accordingly, even though user devices are produced using the same method, the unique characteristic of each user device cannot be cloned. When a PUF is implemented using any of various methods, critical information, such as a secret key generated through the corresponding PUF, is not replicable and is not stored in a separate storage space such as memory, whereby security may be significantly improved. The use of PUF technology is expected to enable more effective implementation of activation of a product, prevention of firmware copying, user device authentication, real-time key generation, and the like.

### DOCUMENTS OF RELATED ART

(Patent Document 1) Korean Patent Application Publication No. 10-2019-0052631, published on May 16, 2019 and titled “Remote reenrollment of physical unclonable functions”
(Patent Document 2) Korean Patent No. 10-1859606, published on Dec. 8, 2017 and titled “Key management device”
(Patent Document 3) Korean Patent Application Publication No. 10-2015-0135032, published on Dec. 2, 2015 and titled “System and method for updating secret key using physical unclonable function”.

### SUMMARY OF THE INVENTION

An object of the present invention is to provide an apparatus and method for enhancing the security of an IoT user device using Physical Unclonable Function (PUF) technology.

Another object of the present invention is to provide a PUF-based authentication server and a method of operating the same that provide an effective Challenge-Response Pair (CRP) management method for preventing the spread of damage due to exposure of a CRP, based on which a secret key is generated, while minimizing the load on the authentication server.

A further object of the present invention is to provide a PUF-based authentication server and a method of operating the same that provide a method enabling continuous authentication of a user device in order to block a machine-learning-based modeling attack and an authentication-session-hijacking attack.

Yet another object of the present invention is to provide a PUF-based authentication server and a method of operating the same that fundamentally block a machine-learning-based modeling attack by encrypting authentication messages with a secret key generated based on CRP information using a PUF and perform continuous authentication not only at the start time of a session but also throughout the session, thereby enabling more secure authentication of a user device.

The technical objects of the present invention are not limited to the above technical objects, and other technical objects that are not mentioned will be readily understood by a person of ordinary skill in the art from the following description.

A method of operating an authentication server based on a Physical Unclonable Function (PUF) according to an embodiment of the present invention may include transmitting a Challenge-Response Pair (CRP) update request message to a user device when a CRP update event occurs, receiving a CRP update response message from the user device in response to the CRP update request message, generating a secret key corresponding to the CRP update request message, decrypting the CRP update response message using the secret key, and updating a CRP corresponding to the secret key in a database using the decrypted CRP update response message.

According to an embodiment, the method may further include generating the CRP update request message when the CRP update event occurs.

According to an embodiment, the method may further include triggering the CRP update event when a timeout occurs based on a CRP expiration time field of the user device in the database.

According to an embodiment, generating the CRP update request message may include generating the CRP update request message including a first challenge value and a second challenge value, the first challenge value may be a part of the CRP of the user device stored in the database, and the CRP update response message may include a second response value corresponding to the second challenge value.

According to an embodiment, the second response value may be encrypted with a device secret key generated using a first response value corresponding to the first challenge value.

According to an embodiment, generating the secret key may include retrieving the CRP of the user device from the database and generating the secret key for decrypting the CRP update response message using the first challenge value and the first response value of the retrieved CRP.

According to an embodiment, decrypting the CRP update response message may include decrypting the CRP update response message with the secret key in order to acquire the second challenge value and the second response value.

According to an embodiment, the method may further include registering the user device in the database through a mediator device.

According to an embodiment, registering the user device in the database may include performing user authentication using the mediator device, issuing an authentication token to the mediator device after the user authentication is completed, and receiving the authentication token and a device ID from the user device.

According to an embodiment, the method may further include authenticating the user device in response to an authentication request message from the user device.

According to an embodiment, authenticating the user device may include generating an authentication secret key using a CRP stored in the database, generating a random number to be used for authentication of the user device, generating an authentication response message by encrypting the challenge value of the CRP, the device ID of the user device, and the random number with the authentication secret key, transmitting the authentication response message to the user device, and receiving an authentication confirmation message from the user device in response to the authentication response message. The authentication confirmation message may include the random number, and may be encrypted with a device secret key corresponding to the CRP.

According to an embodiment, authenticating the user device may further include decrypting the authentication confirmation message with the authentication secret key, and making a comparison so as to check whether the random number of the decrypted authentication confirmation message matches the generated random number.

According to an embodiment, the method may further include performing authentication for the user device when a timeout occurs based on an authentication expiration time field or a CRP expiration time during an authentication session.

An authentication server based on a Physical Unclonable Function (PUF) according to an embodiment of the present invention may include a database for storing a Challenge-Response Pair (CRP) of at least one user device and a timer for determining whether a timeout occurs based on a CRP expiration time field pertaining to the CRP or an authentication completion time field. When the timeout occurs based on the CRP expiration time field or the authentication completion time field, a CRP update request message may be transmitted to a corresponding user device and a CRP update response message may be received from the user device in response to the CRP update request message.

According to an embodiment, a static authentication operation of the user device may be performed in a boot process when the user device is powered on, and then device continuous authentication for the user device may be performed.

According to an embodiment, a time corresponding to the timeout may be set in an aperiodic manner.

According to an embodiment, when an event alarm is raised through device state monitoring or abnormal behavior detection, an authentication operation for the user device may be performed.

A user device according to an embodiment of the present invention may include at least one processor, memory for storing at least one instruction executed by the at least one processor, and a Physical Unclonable Function (PUF) circuit for generating a response value by receiving a challenge value. The at least one instruction may be executed by the at least one processor so as to receive a message for requesting to update a Challenge-Response Pair (CRP), which includes first and second challenge values, from an authentication server, to generate a first response value, corresponding to the first challenge value, and a second response value, corresponding to the second challenge value, through the PUF circuit, to generate a device secret key corresponding to the first response value, to generate a CRP update response message by encrypting the second challenge value and the second response value with the device secret key, and to transmit the CRP update response message to the authentication server.

According to an embodiment, the user device may register a device ID corresponding thereto in the authentication server through a mediator device, and may request authentication from the authentication server using the device ID.

According to an embodiment, when requesting authentication, the user device may receive a random number encrypted with an authentication secret key corresponding to the CRP from the authentication server, acquire the random number by decrypting the encrypted random number with a device secret key corresponding to the CRP, generate an authentication confirmation message by encrypting the acquired random number with the device secret key, and transmit the authentication confirmation message to the authentication server.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a general process of authenticating a user device based on a PUF;

FIG. 2 is a view illustrating an authentication system according to an embodiment of the present invention;

FIG. 3 is a view illustrating a method for generating a user device ID and a secret key using a weak PUF;

FIG. 4 is a view illustrating a method for generating a user device ID and a secret key using a strong PUF;

FIG. 5 is a view illustrating a process in which a user device ID and a CRP database are generated from an IoT user device produced in a factory at a time of manufacture;

FIG. 6 is a view illustrating a process for registering a new IoT user device at a time of user authentication and user device registration;

FIG. 7 is a ladder diagram illustrating an overall process of authenticating a user device including encryption of authentication messages at a time of user device authentication;

FIG. 8 is a view illustrating a database schema that is stored and managed in an authentication server after authentication of a user device is completed;

FIG. 9 is a ladder diagram illustrating a CRP update process in an authentication system according to an embodiment of the present invention;

FIG. 10 is a view illustrating device continuous authentication in an authentication system according to an embodiment of the present invention; and

FIG. 11 is a view illustrating a user device according to an embodiment of the present invention.

### DESCRIPTION OF THE PREFERRED EMBODIMENTS

The present invention will be described in detail below with reference to the accompanying drawings so that those having ordinary knowledge in the technical field to which the present invention pertains can easily practice the present invention.

Because the present invention may be variously changed and may have various embodiments, specific embodiments will be described in detail below with reference to the accompanying drawings. However, it should be understood that those embodiments are not intended to limit the present invention to specific disclosure forms and that they include all changes, equivalents or modifications included in the spirit and scope of the present invention. It will be understood that, although the terms “first,” “second,” etc. may be used herein to describe various elements, these elements are not intended to be limited by these terms. These terms are only used to distinguish one element from another element. For example, a first element could be referred to as a second element without departing from the scope of rights of the present invention. Similarly, a second element could also be referred to as a first element. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Also, the terms used herein are used merely to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Generally, when Physical Unclonable Function (PUF) technology is used in an authentication field, a unique identifier for identifying each user device and an authentication key may be generated inside the user device without a process of receiving the same from the outside. Also, this PUF-based authentication technology may have a cost reduction effect because there is no need to arrange separate internal nonvolatile memory for storing the identifier and the authentication key. This PUF technology is configured such that circuits have different response values in response to the same challenge value even though the circuits are produced through the same manufacturing process. Accordingly, the Challenge-Response Pair (CRP) comprising the challenge value and the response value of each PUF may be used as the means for authenticating each user device. That is, a CRP database for authenticating user devices is constructed and stored in an authentication server during the manufacturing process, and the CRP generated through the PUF of the user device to be authenticated is compared with the CRP stored in the CRP database, whereby each user device may be authenticated.

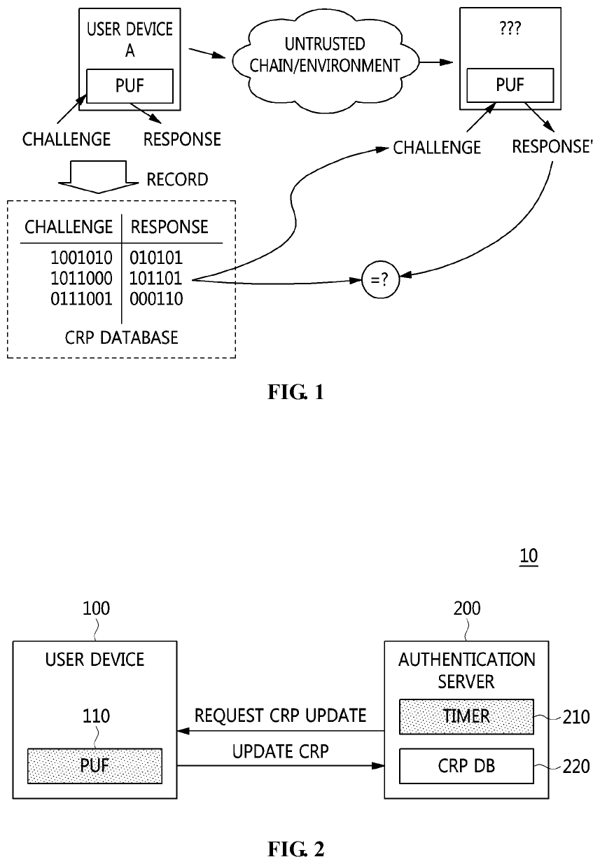

FIG. 1 is a view illustrating a general process of authenticating a user device based on a PUF. An authentication server constructs a CRP database for storing CRPs for respective user devices during a manufacturing process and stores and manages the CRPs.

When an authentication request is received from a user device A, the authentication server transmits a challenge value that is randomly selected from the CRP database to the user device. The user device generates a response value for the received challenge value through a PUF and replies with the response value. The authentication server checks whether the received response value matches the response value for the corresponding challenge value stored in the CRP database, thereby authenticating the corresponding user device A.

Here, a CRP that is already used once is prevented from being reused by being deleted in order to prevent a man-in-the-middle attack or a replay attack. However, in the case of this authentication method based on a PUF, the authentication server must store and manage a large number of CRPs for each user device registered therein. The number of CRPs may increase in proportion to the number of user devices registered in the authentication server. Considering the recent massive Internet-of-Things (IoT) environment, it becomes more difficult for the authentication server to manage CRPs with an increase in the number of user devices. Moreover, when the authentication server is hacked, because the CRP database for all of the user devices managed thereby can be exposed, the authentication server is very vulnerable from a security aspect. Also, the conventional PUF-based authentication method is known as being very vulnerable to a machine-learning-based modeling attack, which is capable of predicting a CRP thanks to the development of artificial-intelligence technology.

Accordingly, required is an effective CRP management method for minimizing the load on the authentication server by reducing the amount of CRP information managed thereby and for minimizing damage due to the exposure of CRPs when the server is hacked. Also, a security enhancement method for blocking a machine-learning-based modeling attack is required. The PUF-based authentication method according to an embodiment of the present invention discloses an effective CRP management method for preventing the spread of damage due to the exposure of a CRP on which to base the generation of a secret key while minimizing the load on the authentication server in order to provide the method for enhancing the security of IoT user devices. Also, the PUF-based authentication method according to an embodiment of the present invention may provide a continuous authentication method for a user device in order to block a machine-learning-based modeling attack and an authentication-session-hijacking attack, which are problems that have recently been the subject of much discussion.

Unlike the existing method, in which all CRPs capable of being generated using a PUF are stored in an authentication server, the PUF-based authentication method according to an embodiment of the present invention stores and manages only one CRP in the authentication server and updates the CRP in the event of a timeout using a timer in order to provide effective CRP management.

The PUF-based authentication method according to an embodiment is configured to generate a secret key based on CRP information using a PUF and to encrypt authentication messages with the generated secret key, thereby fundamentally blocking a machine-learning-based modeling attack and enabling continuous authentication to be performed not only at the start time of a session but also throughout the session. Accordingly, the PUF-based authentication method according to an embodiment of the present invention enables more secure authentication of a user device.

FIG. 2 is a view illustrating an authentication system 10 according to an embodiment of the present invention. Referring to FIG. 2, the authentication system 10 may include a user device 100 and an authentication server 200.

The user device 100 may include a PUF circuit 110. The PUF circuit 110 may be implemented so as to generate a response value in response to a random challenge value. According to an embodiment, the PUF circuit 110 may be implemented using any of various methods, such as an SRAM PUF, a Butterfly PUF, a Bistable Ring PUF, a Digital PUF, a Magnetic PUF, a Metal-Based PUF, a Quantum Confinement PUF, a VIA PUF, a Photonic PUF, and the like.

Also, the user device 100 may receive a request to update a Challenge-Response Pair (CRP) from the authentication server 200, and may transmit the CRP to the authentication server 200.

The authentication server 200 may include a timer 210 and a CRP database 220.

The timer 210 may be used in order to determine a legitimate authentication expiration time of a CRP corresponding to the user device 100.

The CRP database 220 may store the CRP transmitted from the user device 100.

According to an embodiment, the authentication server 200 may transmit a request to update the CRP, of which the authentication expiration time is imminent or has passed, to the user device 100.

The authentication system 10 according to an embodiment of the present invention may provide a user device authentication method based on a PUF in order to enhance the security of the user device 100. The authentication system 10 according to an embodiment of the present invention may reduce the load on the authentication server 200 through an efficient CRP management method, and may prevent the spread of damage by minimizing the exposure of a CRP in the event of hacking.

Also, the authentication system 10 according to an embodiment of the present invention provides an encrypted communication channel using a secret key generated based on CRP information, thereby blocking a machine-learning-based modeling attack and improving the security of the user device 100 through continuous authentication even during an authentications session.

Generally, a weak PUF has no challenge value or has a single fixed challenge value. For example, an SRAM PUF is a representative example of the weak PUF. Accordingly, the weak PUF is rarely used in the authentication field, in which authentication is performed based on a CRP. Generally, the weak PUF is mainly used for user device identity generation, a seed of a random number generator, a root of trust for hardware, and the like. Meanwhile, the authentication apparatus according to an embodiment of the present invention may generate a user device ID and a secret key based on such a weak PUF and use the same for user device authentication.

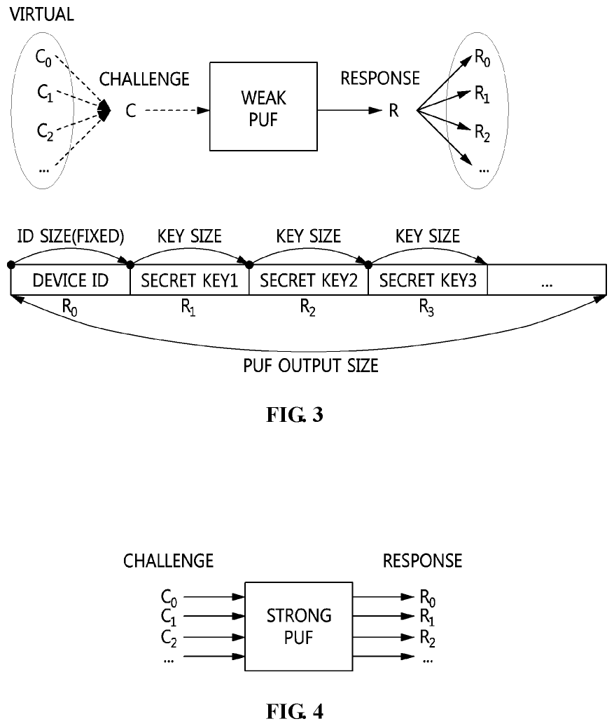

FIG. 3 is a view illustrating a method for generating a user device ID and a secret key using a weak PUF.

An actual challenge value C is the input value of a weak PUF, and the weak PUF may have no actual challenge value, or may only have a single actual challenge value C. The authentication system 10 according to an embodiment of the present invention may generate virtual logical challenge values C₀, C₁, C₂, . . . , and may use these values for authentication of the user device (100 in FIG. 2).

Only one response value R is acquired as the output value of the weak PUF, but the size of the output value is very large (e.g., in the case of an SRAM PUF, the size is in the range of several KB to several MB). Therefore, the response value R is segmented into R₀, R₁, R₂, . . . , so as to be suitable for the sizes of the user device ID and the secret key, whereby the segmented response values may be used.

According to an embodiment, R₀, which is the first segment of the response value R, may be assigned a fixed size so as to be used for the user device ID.

According to an embodiment, the segments R₁, R₂, . . . , of the response value R may be sequentially assigned the size of the secret key so as to be used for the secret key.

Meanwhile, a strong PUF generally has a large number of CRPs available for authentication. An Arbiter PUF is a representative example of such a strong PUF. The authentication system 10 according to an embodiment of the present invention may generate a user device ID and a secret key based on such a strong PUF.

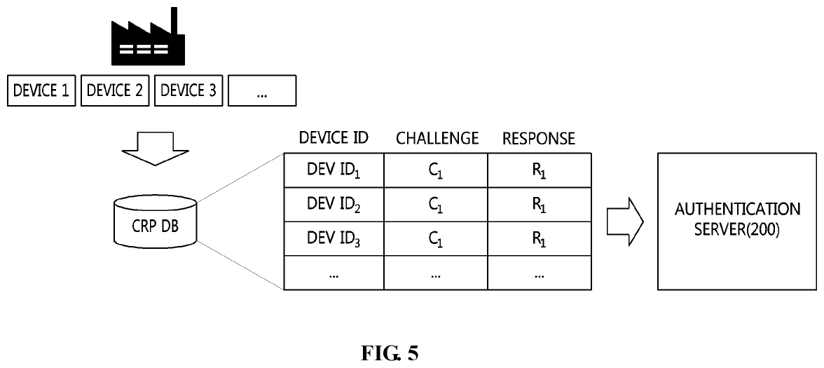

FIG. 4 is a view illustrating a method for generating a user device ID and a secret key using a strong PUF.

In response to challenge values C₀, C₁, C₂, . . . , which are the input values of a strong PUF, response values R₀, R₁, R₂, . . . , which are the output values thereof, may be acquired. R₀ may be assigned and used for the user device ID, and R₁, R₂, . . . , may be assigned and used for the secret key.

Meanwhile, the method for enhancing the security of an IoT user device using a PUF according to an embodiment of the present invention may be applied in a manufacturing phase, a user authentication and device registration phase, a device authentication phase, a continuous authentication phase, and the like.

FIG. 5 is a view illustrating the process of generating a user device ID and a CRP database from an IoT user device produced in a factory at a time of manufacture. Referring to FIG. 5, each user device may register a unique ID based on a PUF and only one initial CRP required for authentication in the CRP database. The generated database may be transmitted to the authentication server 200 so as to be used for authentication of the user device.

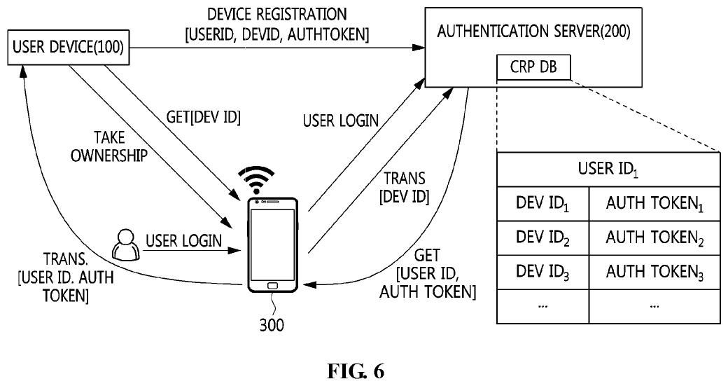

FIG. 6 is a view illustrating a process for registering a new IoT user device at a time of user authentication and device registration. Referring to FIG. 6, after a user purchases a user device 100, the user may perform a registration process as the preparation step of user device authentication.

First, the user may log on to the authentication server 200 using a smart device (e.g., a smartphone) that acts as a mediator 300. Here, the existing Fast Identity Online (FIDO) method, username/password method, or the like, may be used as the login method.

The mediator 300 may take the ownership of the user device 100 in order to register the new IoT user device 100 in the authentication server 200. Then, the mediator 300 may obtain a user device ID DEV ID from the user device 100.

Then, the mediator 300 may transmit the obtained user device ID DEV ID to the authentication server 200. The mediator 300 may receive a user ID UserID and an authentication token AUTH TOKEN from the authentication server 200. The mediator 300 may transmit the user ID UserID and the authentication token AUTH TOKEN, which are received from the authentication server 200, to the user device 100.

The user device 100 may receive the user ID UserID and the authentication token AUTH TOKEN from the mediator 300, and may transmit the received user ID UserID, the user device ID DEV ID, and the authentication token AUTH TOKEN to the authentication server 200.

Then, the authentication server 200 receives the user ID UserID, the user device ID DEV ID, and the authentication token AUTH TOKEN from the user device 100, thereby completing registration of the user device 100.

When the process of registering the user device 100 is completed as described above, the authentication server 200 may manage information about the user device possessed by each user through a database. Then, when it receives a request to authenticate a user device, the authentication server 200 may perform a user device authentication operation based on the information corresponding to the request to authenticate the user device.

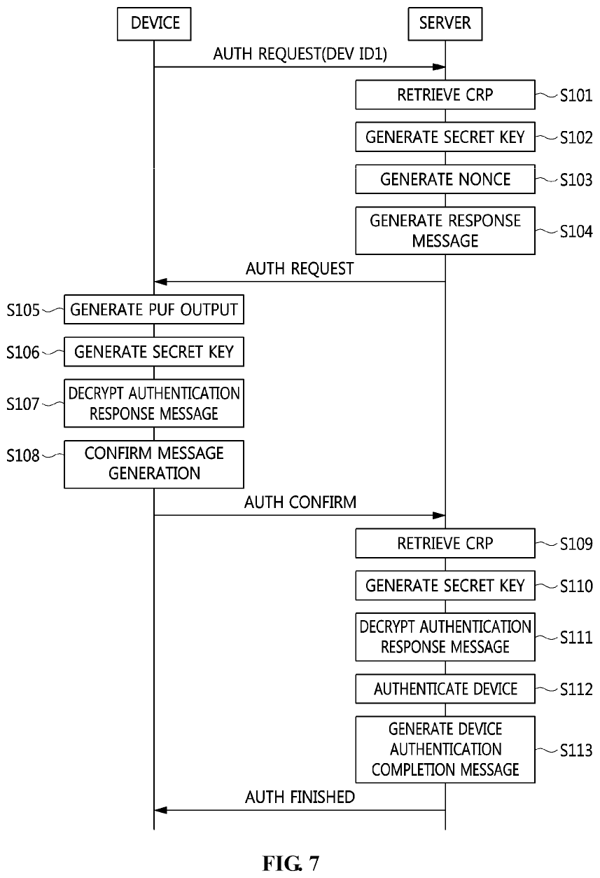

FIG. 7 is a ladder diagram illustrating an overall process of authenticating a user device including encryption of authentication messages at a time of user device authentication. Referring to FIG. 7, the authentication operation for the user device 100 may be performed as follows.

The user device 100 may generate an authentication request message AUTH REQUEST using the unique user device ID DEV ID₁ thereof and transmit the same to the authentication server 200.

The authentication server 200 may retrieve the initial CRP (C₁, R₁) of the user device ID DEV ID₁, which has been registered in advance, from the CRP database 220 at step S101 in order to perform user device authentication. The authentication server 200 may generate a secret key K₁ for encrypting an authentication message using the retrieved challenge value C₁ and the retrieved response value R₁ at step S102. Here, the corresponding secret key may be a symmetric key. According to an embodiment, the secret key K₁ may be generated through a hash function by further combining additional information, such as the user device ID DEV ID₁ and the like. The authentication server 200 may generate a random number to be used for user device authentication, that is, a nonce N₁, at step S103. Then, the authentication server 200 may generate an authentication response message AUTH RESPONSE; C₁∥E_{K1}(DEV ID₁∥N₁) at step S104 by encrypting the received user device ID DEV ID₁ and the generated nonce N₁ with the secret key K₁ and combining the retrieved challenge value C₁ with the encrypted value, and may transmit the generated authentication response message AUTH RESPONSE; C₁∥E_{K1}(DEV ID₁∥N₁) to the user device 100. Here, any one encryption algorithm selected from among various symmetric key cryptography methods, such as Data Encryption Standard (DES), Advanced Encryption Standard (AES), and the like, may be used. The encryption algorithm may be executed in consideration of the resources of the user device 100.

The user device 100 may generate a user device ID DEV ID₁′ from the PUF circuit 110 using the challenge value C₀, and may generate a response value R₁′ of the PUF circuit 110 using the received challenge value C₁ at step S105.

The user device 100 may generate a secret key K₁′ for decrypting the authentication response message AUTH RESPONSE; C₁∥E_{K1}(DEV ID₁∥N₁) using the received challenge value C₁ and the generated response value R₁′ at step S106. The user device 100 decrypts the encrypted authentication response message AUTH RESPONSE; C₁∥E_{K1}(DEV ID₁∥N₁) with the generated secret key K₁′, thereby acquiring the user device ID DEV ID₁ and the nonce N₁ at step S107. The user device 100 may compare the user device ID DEV ID₁′ generated from the PUF circuit 110 with the user device ID DEV ID₁ acquired through decryption in order to perform server authentication. When the two user device IDs match, the user device 100 determines that server authentication has succeeded and performs the next process. However, when the two user device IDs do not match, the user device 100 may generate an appropriate error and transmit the same to the authentication server 200. The user device 100 may generate an authentication confirmation message AUTH CONFIRM; DEV ID₁∥E_{K1′}(N₁′) at step S108 by generating a nonce N₁′ having the same value as the nonce N₁, encrypting the nonce N₁′ with the generated secret key K₁′, and combining the acquired user device ID DEV ID₁ with the encrypted value, and may transmit the generated authentication confirmation message AUTH CONFIRM; DEV ID₁∥E_{K1′}(N₁′) to the authentication server 200.

Then, the authentication server 200 may retrieve the CRP (C₁, R₁) of the received user device ID DEV ID₁ from the CRP database 220 at step S109 in order to perform user device authentication. The authentication server 200 may generate a secret key K₁ for decrypting the authentication confirmation message AUTH CONFIRM; DEV ID₁∥E_{K1′}(N₁′) using the retrieved challenge value C₁ and the retrieved response value R₁ at step S110. The authentication server 200 decrypts the encrypted authentication confirmation message AUTH CONFIRM; DEV ID₁∥E_{K1′}(N₁′) with the generated secret key K₁, thereby acquiring the nonce N₁′ (N₁′=D_{K1}(E_{K1′}(N₁′))) at step S111. Then, the authentication server 200 may compare the nonce N₁′ acquired through the decryption operation with the nonce N₁ generated at step S103 in order to perform user device authentication. When the nonce N₁′ matches the nonce N₁, the authentication server 200 determines that user device authentication has succeeded at step S112 and performs the next process. Conversely, when the nonce N₁′ does not match the nonce N₁, the authentication server 200 may generate an appropriate error and transmit the same to the user device 100.

Through the above-described process, mutual authentication between the user device 100 and the authentication server 200 may be completed. The authentication server 200 may generate an authentication finalization message AUTH FINISHED as the final result of user device authentication at step S113 and transmit the same to the user device 100.

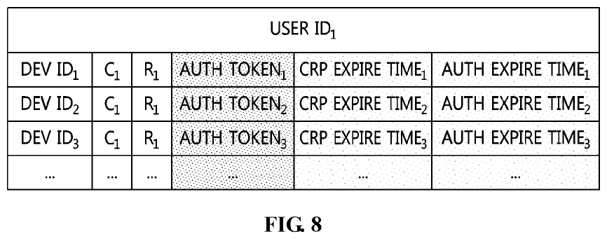

FIG. 8 is a view illustrating a database schema that is stored and managed in an authentication server after user device authentication is completed. Referring to FIG. 8, a field for an authentication token AUTH TOKEN for registering a user device, a field for a first expiration time CRP EXPIRE TIME for updating a CRP, a field for a second expiration time AUTH EXPIRE TIME for continuous user device authentication, and the like may be added, in addition to a field for a user device ID DEV ID, a field for a challenge value C, and a field for a response value field R, which are generated at the time of manufacture of a user device and used for authentication.

Here, the field for the first expiration time CRP EXPIRE TIME is for providing an effective CRP management method. The database (220 in FIG. 2) may store and manage only a single CRP for each user device. When a timeout occurs based on the field for the first expiration time CRP EXPIRE TIME, the authentication server 200 may trigger an event for updating a CRP. When the event for updating the CRP has occurred, the authentication server 200 may generate a CRP update request message CRP UPDATE REQUEST and transmit the same to the user device.

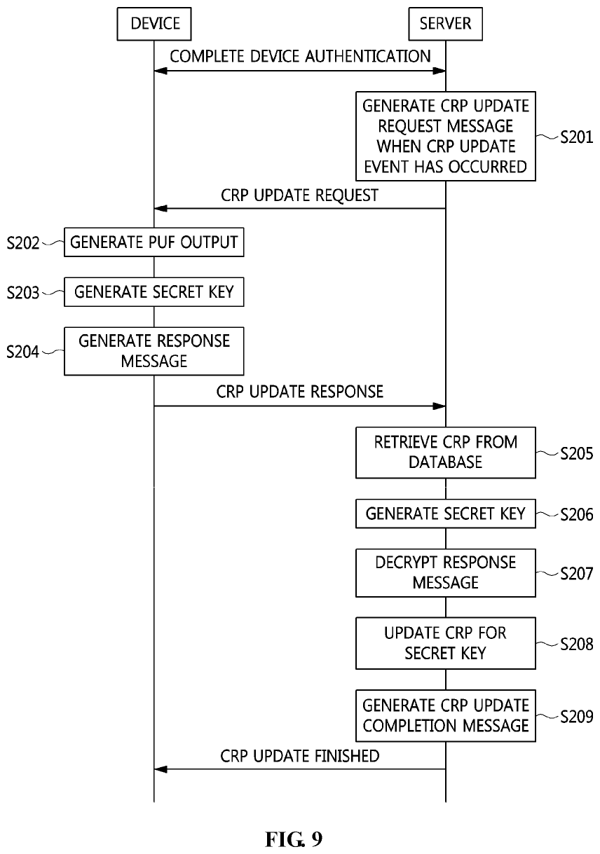

FIG. 9 is a ladder diagram illustrating a CRP update process in an authentication system 10 according to an embodiment of the present invention. Referring to FIG. 9, the CRP update process may be performed as follows. Here, because a secret key is generated based on a CRP, the update of the CRP means the update of the secret key.

First, when a CRP update event has occurred, the authentication server 200 may generate a CRP update request message CRP UPDATE REQUEST using challenge values C₁ and C₂ and transmit the same to the user device 100 at step S201.

The user device 100 may generate a user device ID DEV ID₁ from the PUF circuit 110 through the challenge value C₀, and may generate response values R₁′ and R₂′ from the PUF circuit 110 through the received challenge values C₁ and C₂ at step S202. The user device 100 may generate a secret key K₁′ for encrypting an update response message CRP UPDATE RESPONSE using the received challenge value C₁ and the generated response value R₁′ at step S203. The user device 100 may generate a CRP update response message CRP UPDATE RESPONSE at step S204 by encrypting the received challenge value C₂ and the generated response value R₂′ with the generated secret key K₁′ and combining the user device ID DEV ID₁ with the encrypted value, and may transmit the generated CRP update response message CRP UPDATE RESPONSE to the authentication server 200.

The authentication server 200 may retrieve the CRP (C₁, R₁) of the received user device ID DEV ID₁ from the CRP database 220 at step S205 in order to update the CRP. The authentication server 200 may generate a secret key K₁ for decrypting the update response message CRP UPDATE RESPONSE using the retrieved challenge value C₁ and the retrieved response value R₁. The authentication server 200 decrypts the encrypted update response message CRP UPDATE RESPONSE with the generated secret key K₁, thereby acquiring the challenge value C₂ and the response value R₂ at step S207.

Then, the authentication server 200 may update the existing CRP (C₁, R₁) stored in the CRP database 220 by changing the same to the new CRP (C₂, R₂). Through the above-described process, the update of the secret key corresponding to the user device 100 may be performed.

Then, the authentication server 200 may generate a CRP update completion message CRP UPDATE FINISHED corresponding to the final result of the CRP update at step S209, and may transmit the CRP update completion message CRP UPDATE FINISHED to the user device 100.

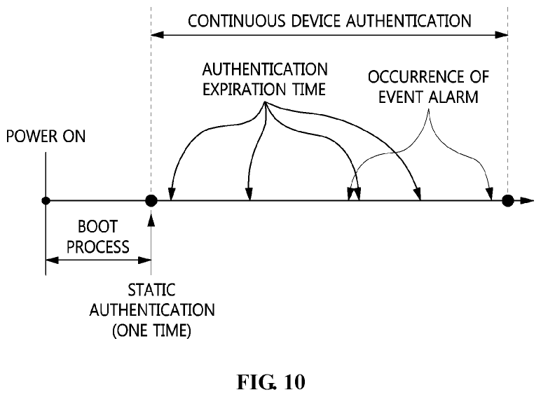

FIG. 10 is a view illustrating device continuous authentication in the authentication system 10 according to an embodiment of the present invention.

A general authentication method is configured such that, when a user device is powered on, an initial boot process and one-time authentication are performed, and then no additional authentication process is performed during a corresponding authentication session. This allows hackers to make an authentication-session-hijacking attack, whereby the user device becomes vulnerable to security attacks. In order to overcome the limitation of one-time authentication from a user authentication aspect, a continuous authentication method, in which, even after the first authentication, habitual patterns of typing on a keyboard or clicking a mouse are learned and further authentication is requested when the current pattern deviates from the habitual pattern, is required.

Meanwhile, the authentication system 10 according to an embodiment of the present invention applies a continuous authentication concept from a user device authentication aspect.

Because the field for the authentication expiration time AUTH EXPIRE TIME is included in the items to be managed for a CRP, the authentication server 200 may easily detect whether a timeout related to device authentication occurs using the authentication expiration time. Therefore, the authentication server 200 may perform user device authentication during the authentication session.

According to an embodiment, a timeout period may be set in a non-periodic manner in order to prevent a hacker from predicting the timeout period.

According to an embodiment, when an event alarm is raised as the result of monitoring of a user device state, detection of abnormal operation, or the like, the authentication server 200 may perform user device authentication. Such a continuous user device authentication function based on the time and events may improve the weak security of an IoT user device.

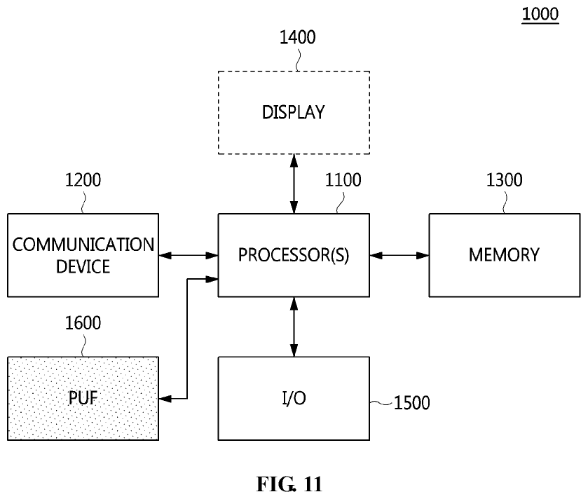

FIG. 11 is a view illustrating a user device 1000 according to an embodiment of the present invention. Referring to FIG. 11, the user device 1000 may include at least one processor 1100, a network interface 1200, memory 1300, a display 1400, an I/O device 1500, and a PUF circuit 1600.

The processor 1100 may include at least one of the devices described with reference to FIGS. 1 to 10, or may be implemented using at least one of the methods described with reference to FIGS. 1 to 10. The processor 1100 may execute instructions so as to receive a Challenge-Response Pair (CRP) update request message including first and second challenge values from an authentication server, to generate a first response value and a second response value, which correspond to the first challenge value and the second challenge value, respectively, through the PUF circuit 1600, to generate a device secret key corresponding to the first response value, to generate a CRP update response message by encrypting the second challenge value and the second response value with the device secret key, and to transmit the CRP update response message to the authentication server, as described above.

The processor 1100 may run programs and control the user device 1000. The user device 1000 may be connected with an external device (e.g., a personal computer or a network) and may exchange data therewith via the I/O devices 1500. The user device 1000 may include various electronic devices, including mobile devices such as a mobile phone, a smartphone, a PDA, a tablet PC, a laptop computer, and the like, computing devices such as a PC, a tablet PC, a netbook, and the like, and electronic products such as a TV, a smart TV, a security device for gate control, and the like.

The network interface 1200 may be implemented so as to communicate with an external network using any of various wired/wireless methods.

The memory 1300 may store computer-readable instructions. The processor 1100 may perform the above-described operations by executing the instructions stored in the memory 1300. The memory 1300 may be volatile or nonvolatile memory. The memory 1300 may include a storage device for storing user data. The storage device may be an embedded multimedia card (eMMC), a solid-state drive (SSD), universal flash storage (UFS), or the like. The storage device may include at least one nonvolatile memory device. The nonvolatile memory device may be any of NAND flash memory, Vertical NAND (VNAND), NOR flash memory, Resistive Random-Access Memory (RRAM), Phase-Change Memory (PRAM), Magnetoresistive Random-Access Memory (MRAM), Ferroelectric Random-Access Memory (FRAM), Spin-Transfer-Torque Random-Access Memory (STT-RAM), and the like.

The embodiments described above may be implemented through hardware components, software components, and/or a combination thereof. For example, the apparatus, method and components described in the embodiments may be implemented using one or more general-purpose computers or special-purpose computers, for example, a processor, a controller, an arithmetic logic unit (ALU), a digital signal processor, a microcomputer, a field-programmable gate array (FPGA), a programmable logic unit (PLU), a microprocessor, or any other device capable of executing instructions and responding thereto. The processing device may run an operating system (OS) and one or more software applications executed on the OS.

Also, the processing device may access, store, manipulate, process and create data in response to execution of the software. For the convenience of description, the processing device is described as a single device, but those having ordinary skill in the art will understand that the processing device may include multiple processing elements and/or multiple forms of processing elements. For example, the processing device may include multiple processors or a single processor and a single controller. Also, other processing configurations such as parallel processors may be available.

The software may include a computer program, code, instructions, or a combination thereof, and may configure a processing device to be operated as desired, or may independently or collectively instruct the processing device to be operated. The software and/or data may be permanently or temporarily embodied in a specific form of machines, components, physical equipment, virtual equipment, computer storage media or devices, or transmitted signal waves in order to be interpreted by a processing device or to provide instructions or data to the processing device. The software may be distributed across computer systems connected with each other via a network, and may be stored or run in a distributed manner. The software and data may be stored in one or more computer-readable storage media.

The method according to the embodiments may be implemented as program instructions executable by various computer devices, and may be recorded in computer-readable storage media. The computer-readable storage media may individually or collectively include program instructions, data files, data structures, and the like. The program instructions recorded in the media may be specially designed and configured for the embodiment, or may be readily available and well known to computer software experts. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter or the like. The above-mentioned hardware device may be configured so as to operate as one or more software modules in order to perform the operations of the embodiment, and vice-versa.

The present invention provides a method for enhancing the security of an IoT user device using PUF technology. The present invention provides an effective CRP management method for preventing the spread of damage due to the exposure of a CRP, based on which a secret key is generated, while minimizing the load on an authentication server, and provides a continuous user device authentication method capable of blocking a machine-learning-based modeling attack and an authentication-session-hijacking attack, which are problems that have recently been the subject of much discussion.

The present invention provides an authentication method that minimizes user intervention so as to be applicable in a large-scale IoT environment, obviates the need to input information such as a user device identifier, a secret key, and the like from the outside owing to the use of PUF technology, and fundamentally prevents the risk of exposure of important information because such important information is not stored in a separate storage space, such as memory, thereby improving security. Also, the present invention incurs no additional expense and has no risk of replication when it is compared with hardware solutions, such as a hardware security module (HSM), a secure element (SE), a trusted platform module (TPM), a trust zone, and the like. The present invention provides a symmetric-key-based mutual authentication method applicable even to lightweight IoT user devices (classified as Classes 1 and 2) defined by IETF (RFC7228) and effectively blocks a man-in-the-middle attack and a replay attack. A method for making a weak PUF, which is rarely used in the existing authentication field, available for user device authentication is provided, and an IoT user device is made more secure by applying a continuous authentication method to user device authentication.

When the method for enhancing the security of an IoT user device using a PUF provided by the present invention is applied in a large-scale IoT environment having weak security, security incidents, such as information leakage by hacking, DDoS attacks, and damage due to illegal replication or falsification, are prevented, whereby it is expected that economic and social losses incurred therefrom will be significantly reduced.

A PUF-based authentication server and a method of operating the same according to an embodiment of the present invention may provide a method for enhancing the security of an IoT user device using PUF technology.

A PUF-based authentication server and a method of operating the same according to an embodiment of the present invention may provide an effective CRP management method for preventing the spread of damage due to the exposure of a CRP, based on which a secret key is generated, while minimizing the load on the authentication server.

A PUF-based authentication server and a method of operating the same according to an embodiment of the present invention may provide a method enabling continuous authentication of a user device in order to block a machine-learning-based modeling attack and an authentication-session-hijacking attack.

A PUF-based authentication server and a method of operating the same according to an embodiment of the present invention are applicable in a large-scale IoT environment by providing an authentication method that minimizes user intervention.

A PUF-based authentication server and a method of operating the same according to an embodiment of the present invention obviate the need to input information such as a user device identifier, a secret key, and the like from the outside using PUF technology, and fundamentally prevent a risk of exposure of important information because such important information is not stored in a separate storage space, such as memory, thereby improving security.

A PUF-based authentication server and a method of operating the same according to an embodiment of the present invention incur no additional expense and have no risk of replication when compared with hardware solutions, such as a hardware security module (HSM), a secure element (SE), a trusted platform module (TPM), a trust zone, and the like.

A PUF-based authentication server and a method of operating the same according to an embodiment of the present invention may provide a symmetric-key-based mutual authentication method that is applicable even to lightweight IoT user devices (classified as Classes 1 and 2) defined by IETF (RFC7228).

A PUF-based authentication server and a method of operating the same according to an embodiment of the present invention may effectively block a man-in-the-middle attack and a replay attack.

A PUF-based authentication server and a method of operating the same according to an embodiment of the present invention may make a weak PUF available for authentication of a user device.

A PUF-based authentication server and a method of operating the same according to an embodiment of the present invention apply a continuous authentication method to authentication of a user device, thereby making the IoT user device more secure.

A PUF-based authentication server and a method of operating the same according to an embodiment of the present invention may apply a method for enhancing the security of IoT user devices using a PUF in a large-scale IoT environment, which is vulnerable to security attacks, thereby preventing security incidents, such as information leakage by hacking, DDoS attacks, damage due to illegal replication or falsification, and the like, and significantly reducing economic and social losses incurred therefrom.

Meanwhile, the above description is merely of specific embodiments for practicing the present invention. The present invention encompasses not only concrete and available means but also the technical spirit corresponding to abstract and conceptual ideas that may be used as future technology.

What is claimed is:

1. A method of operating an authentication server based on a Physical Unclonable Function (PUF), comprising:
transmitting a Challenge-Response Pair (CRP) update request message to a user device when a CRP update event occurs;
receiving a CRP update response message from the user device in response to the CRP update request message;
generating a secret key corresponding to the CRP update request message;
decrypting the CRP update response message using the secret key; and
updating a CRP corresponding to the secret key in a database using the decrypted CRP update response message.

2. The method of claim 1, further comprising:
generating the CRP update request message when the CRP update event occurs.

3. The method of claim 2, further comprising:
triggering the CRP update event when a timeout occurs based on a CRP expiration time field of the user device in the database.

4. The method of claim 2, wherein generating the CRP update request message comprises:
generating the CRP update request message including a first challenge value and a second challenge value,
wherein:
the first challenge value is a part of the CRP of the user device stored in the database, and
the CRP update response message includes the second challenge value and a second response value corresponding to the second challenge value.

5. The method of claim 4, wherein the second response value is encrypted with a device secret key generated using a first response value corresponding to the first challenge value.

6. The method of claim 4, wherein generating the secret key comprises:
retrieving the CRP of the user device from the database; and
generating the secret key for decrypting the CRP update response message using the first challenge value and a first response value of the retrieved CRP.

7. The method of claim 4, wherein decrypting the CRP update response message comprises:
decrypting the CRP update response message with the secret key in order to acquire the second challenge value and the second response value.

8. The method of claim 1, further comprising:
registering the user device in the database through a mediator device.

9. The method of claim 8, wherein registering the user device in the database comprises:
performing user authentication using the mediator device;
issuing an authentication token to the mediator device after the user authentication is completed; and
receiving the authentication token and a device ID from the user device.

10. The method of claim 1, further comprising:
authenticating the user device in response to an authentication request message from the user device.

11. The method of claim 10, wherein authenticating the user device comprises:
generating an authentication secret key using a CRP stored in the database;
generating a random number to be used for authentication of the user device;
generating an authentication response message by encrypting a challenge value of the CRP, a device ID of the user device, and the random number with the authentication secret key;
transmitting the authentication response message to the user device; and
receiving an authentication confirmation message from the user device in response to the authentication response message,
wherein the authentication confirmation message includes the random number and is encrypted with a device secret key corresponding to the CRP.

12. The method of claim 11, wherein authenticating the user device further comprises:
decrypting the authentication confirmation message with the authentication secret key; and
making a comparison so as to check whether a random number of the decrypted authentication confirmation message matches the generated random number.

13. The method of claim 1, further comprising:
performing authentication for the user device when a timeout occurs based on an authentication expiration time field or a CRP expiration time field during an authentication session.

14. An authentication server based on a Physical Unclonable Function (PUF), comprising:
a database for storing a Challenge-Response Pair (CRP) of at least one user device; and
a timer for determining whether a timeout occurs based on a CRP expiration time field pertaining to the CRP or an authentication completion time field,
wherein, when the timeout occurs based on the CRP expiration time field or the authentication completion time field, a CRP update request message is transmitted to a corresponding user device and a CRP update response message is received from the user device in response to the CRP update request message.

15. The authentication server of claim 14, wherein a static authentication operation of the user device is performed in a boot process when the user device is powered on, and then device continuous authentication for the user device is performed.

16. The authentication server of claim 14, wherein a time corresponding to the timeout is set in an aperiodic manner.

17. The authentication server of claim 14, wherein, when an event alarm is raised through device state monitoring or abnormal behavior detection, an authentication operation for the user device is performed.

18. A user device, comprising:
at least one processor;
memory for storing at least one instruction executed by the at least one processor; and
a Physical Unclonable Function (PUF) circuit for generating a response value by receiving a challenge value,
wherein the at least one instruction is executed by the at least one processor so as to:
receive a message for requesting to update a Challenge-Response Pair (CRP) from an authentication server, the message including first and second challenge values;
generate a first response value, corresponding to the first challenge value, and a second response value, corresponding to the second challenge value, through the PUF circuit;
generate a device secret key corresponding to the first response value;
generate a CRP update response message by encrypting the second challenge value and the second response value with the device secret key; and
transmit the CRP update response message to the authentication server.

19. The user device of claim 18, wherein the user device registers a device ID corresponding thereto in the authentication server through a mediator device and requests authentication from the authentication server using the device ID.

20. The user device of claim 18, wherein, when requesting authentication, the user device receives a random number encrypted with an authentication secret key corresponding to the CRP from the authentication server, acquires the random number by decrypting the encrypted random number with a device secret key corresponding to the CRP, generates an authentication confirmation message by encrypting the acquired random number with the device secret key, and transmits the authentication confirmation message to the authentication server.
